(19) United States
(12) Patent Application Publication
(10) Pub. No.: US 2002/0185112 A1
(43) Pub. Date: Dec. 12, 2002

(54) Fuel injector with direct needle valve control

(76) Inventor: Ning Lei, Addison, IL (US)

Correspondence Address: INTERNATIONAL ENGINE, INTELLECTUAL PROPERTY COMPANY, LLC., 4201 WINFIELD ROAD, P.O. BOX 1488, WARRENVILLE, IL, 60555, US

(21) Appl. No.: 10/205,252

(22) Filed: Jul. 25, 2002

Related U.S. Application Data
(63) Continuation-in-part of application No. 09/365,965, filed on Aug. 2, 1999.
(60) Provisional application No. 60/104,662, filed on Oct. 16, 1998.

(51) Int. Cl. F02M 47/02

(52) U.S. Cl. 123/446; 239/88

(57) ABSTRACT

A hydraulically-actuated unit fuel injector of the intensifier type is provided with two independently operable active control valves. A selectively actuable fuel pressure control valve is disposed on the hydraulic actuation fluid side to control the fuel pressure actuation process and provide a window of injection opportunity wherein the fuel pressure is maintained at high pressure. A selectively actuable timing control valve is disposed on the high pressure fuel side to provide precise control of injection timing events and duration, such as start of injection, end of injection, timing of interruption and duration of interruption, which all may occur during a single injection event within the window of opportunity. The timing control valve may take various forms including piezo controlled direct needle actuation valves and common rail injector needle control valves. Both control valves are independently controlled to prevent reverse motion of the intensifier piston and plunger during dwell or interruption of injection while maintaining the full injection pressure. Dwell or interruption is controlled by using the timing control valve to port fuel under pressure to a fuel injector needle valve surface to generate a force on the fuel injector needle valve surface acting to close the fuel injector needle valve. Methods of defining a fuel injection event fuel injector having a fuel pressure intensifier, includes the steps of (a) preparing fuel pressure with a fuel injection pressure control valve, and (b) controlling the timing of a fuel injection event with a fuel injection timing control valve, the fuel pressure preparation and the timing of the fuel inject event being independently controllable. Preferably, full intensified fuel pressure is made available to the injector throughout a single injection event which may include a pilot injection, a main injection, a rate-shaped injection, and dwell periods wherein no injection occurs. Various methods of operating the fuel injector to provide various functions during a single injection event are also disclosed.

### RELATED APPLICATIONS

This application is a continuation-in-part of U.S. Non-Provisional application Ser. No. 09/365,965, filed Aug. 2, 1999 which claims the benefit of U.S. Provisional Application Serial No. 60/104,662, filed Oct. 16, 1998.

### BACKGROUND OF THE INVENTION

This invention is related to the fuel supply for internal combustion engines and, more particularly, to a fuel injector having two active control valves to control needle valve motion. One control valve is used to control the injection pressure process. The second control valve is used to directly control the fuel injector needle valve. Depending on the coordination between two control valves, different injection characteristics are obtained as desired.

### THE PRIOR ART

A hydraulically-actuated, electronically-controlled, unit injector (HEUI), of the type described in U.S. Pat. No. 5,181,494 and in SAE Technical Paper Series 930270, HEUI—A New Direction for Diesel Engine Fuel Systems, S. F Glassey, at al, March 1-5,1993, which are incorporated herein by reference, is depicted in prior art FIG. 1.

The prior art HEUI 200 is depicted in prior art FIG. 1. HEUI 200 consists of four main components: (1) control valve 202; (2) intensifier 204; (3) nozzle 206; and (4) injector housing 208.

The purpose of the control valve 202 is to initiate and end the injection process. Control valve 202 is comprised of a poppet valve 210, and electric control 212 having an armature and solenoid. High pressure actuating oil is supplied to the lower seat 214 of the valve 210 through oil passageway 216. To begin injection, the solenoid of electric control 212 is energized, moving the poppet valve 210 upward off the lower seat 214 to the upper seat 218. This action admits high pressure oil to the spring cavity 220 and the passage 222 to the intensifier 204. Injection commences and continues until the solenoid of the control 212 is de-energized and the poppet 210 moves from the upper seat 218 to lower seat 214. Oil and fuel pressure decrease as spent actuating oil is ejected from the injector 200 through the open upper seat oil discharge 224 to the valve cover area (not shown) of the internal combustion engine.

The middle segment of the injector 200 is comprised of the hydraulic intensifier piston 236, the plunger 228, the plunger chamber 230, and the plunger return spring 232.

Intensification of the fuel pressure to desired injection pressure levels is accomplished by the ratio of areas between the upper surface 234 of the intensifier piston 236 and the lower surface 238 of the plunger 228. The intensification ratio can be tailored to achieve desired injection characteristics. Injection begins as high pressure actuating oil is supplied to the upper surface 234 of the intensifier piston 236. Fuel is admitted to the plunger chamber 230 (formed in part by lower surface 238) through passageway 240 past check valve 242.

As the piston 236 and plunger 228 move downward, the pressure of the fuel in plunger chamber 230 below the lower surface 238 of the plunger 228 rises. High pressure fuel flows in passageway 244 past check valve 246 to act upward on needle valve 250. The upward force opens needle valve 250 and fuel is discharged from orifice 252. The piston 236 continues to move downward until the solenoid of the control 212 is de-energized, causing the poppet 210 to return to the lower seat 214, thereby blocking actuating oil flow. Oil pressure above the intensifier piston is now vented to the ambient through drain passage 224. The plunger return spring 232 returns the piston 236 and plunger 228 to their initial positions. As the plunger 228 returns, the plunger 228 draws replenishing fuel into the plunger chamber 230 across ball check valve 242.

The nozzle 206 is typical of other diesel fuel system nozzles. The valve-closed-orifice style is shown, although a mini-sac version of the tip is also available. Fuel is supplied to the nozzle orifice 252 through internal passages. As fuel pressure increases, the nozzle needle valve 250 is lifted from the lower seat 254 (compressing spring 256), thereby opening the needle valve 250 and causing fuel injection to occur. As fuel pressure decreases at the end of injection, the spring 256 returns the needle valve 250 to its closed position on the lower seat 254.

The HEUI Intensifier System

For all unit injectors in production today, there is only one active control valve in each injector. Fuel injectors are typically of the common rail or intensifier types. The common rail type (Lucas and Bosch type systems) has a very high pressure fuel rail that supplies fuel to the injector at a pressure ready for injection, on the order of 20,000 psi. The intensifier injector (HEUI type) includes an intensifier plunger in the injector itself to bring low supply fuel pressure to a desired injection pressure level internally. This process is as described above.

One of very desired characteristics of the HEUI intensifier system is its similarity in performance to the Bosch type pump and nozzle injection system (cam system), where injection pressure is gradually built up during an injection event. This gradual building up process produces a generally triangle shaped rate-of-injection single shot injection event where the initial portion of the injection pressure rate trace rises gradually, as distinct from a sharp rising. See FIG. 3, case 4. This type of injection rate trace provides a benefit to reduce NOx emissions at high speed engine operation. This is a very special feature of the intensifier system. Common rail systems can not produce this feature.

In the HEUI injector concept shown in U.S. Pat. No. 5,460,329, pilot injection is produced through double action of a single spool digital control valve. The result is similar to the solid line injection event depicted in FIG. 3, case 1. The entire injection event, having a pilot injection event preceding a main injection event, is considered as two independent, pulse-width-controlled, single injection events occurring in very close sequence. The pilot portion of injection is a single shot of injection but with very short pulse width. With this philosophy, the intensifier chamber pressure is vented to terminate the pilot injection at the end of the pilot injection event and recharged again to start the main injection.

The HEUI B injector, described in U.S. Pat. No. 5,682,858, improves its performance by using direct control of the needle valve. However, the intensifier is also passively controlled by the same control valve. The actuation process is not totally independent of needle timing control. This type of injector cannot have fully flexible injection timing and rate shaping control across the whole engine speed and load range. It may have difficulty producing certain dwell and certain pilot injection size when the actuation pressure is mismatched. Another desirable characteristic of the intensifier system is its product safety. High injection pressure is developed within the injector only during a short period durng the engine cycle, only during the time window where injection events are going to occur, as distinct from a high pressure common rail system. The injector stays in a low pressure environment for the rest of the engine cycle. Additionally, there is no external plumbing required to transport fuel from a high pressure pump to the injector as in the common rail system. Compared to the common rail system, the intensifier system demonstrates a much superior advantage that appeals to a large number of engine manufacturers.

Common Rail Systems (Lucas & Bosch Type Systems)

The common rail fuel system is very different from the previously described injectors that incorporate an intensifier system. In the common rail system, the injector is not responsible for the injection pressure development process. Rather, the high pressure fuel, on the order of 20,000 psi is delivered to the injector from the common rail ready for injection into the combustion chamber of an engine. The injector has direct timing control of the injector needle valve with a relatively simple timing control process to produce the desired pilot injection and injection event dwell (duration). Injection timing and duration are purely a timing issue. In any unit injection system, the speed of control valve response is considered as the most crucial element and the limiting factor for achieving small pilot and small dwell size especially under high engine speed and high injection pressure operation conditions. Using one control valve to handle both pressure and timing, as in the intensifier system, can be very challenging and limiting. Thus, decoupling the pressure development process from the timing control process becomes a necessary step to further improve injection system performance in the future. The common rail system by its nature is decoupled, being responsible only for timing. For this reason, the common rail system has much superior control of the pilot size and dwell duration due to its direct needle control and independent fuel pressure control outside of the injector as compared to the intensifier system.

Both the Lucas and the Bosch type unit injectors have only one active control valve on each injector. For both of them, the single control valve is used to directly control the timing of the needle valve opening and closing. The sole function of the control valve in a common rail system is control of the timing of injection events (e.g., starting, ending and duration of the injection).

Timing control of the fuel injector is highly dependent on the response time of the control valve. For this reason, the Lucas type system apparently has better response than the Bosch type system due to its faster response of the control valve.

### SUMMARY OF THE INVENTION

The present invention injector has the advantages of both the intensifier system and the common rail system, while substantially avoiding the problems of the two systems as indicated below.

Decoupling The Injection Pressure Preparation From Timing Control Without Going To A High Pressure Common Rail.

This is achieved by having two active control valves in one unit injector of the intensifier type. One control valve (the pressure control valve) is on the actuation liquid side and other control valve (the timing control valve) is on the high pressure fuel side. In order to maintain the advantages of the intensifier system, the pressure control valve is used to control the pressure actuation process. The pressure control valve is responsible for opening up the window of injection opportunity. The timing control valve is responsible for controlling when and how long the injection event takes place within the window of opportunity. This two control valve system is the marriage between the intensifier system and the common rail system. The present invention keeps the advantages of both systems (intensifier and common rail) and provides the opportunity to eliminate the undesired characteristics of each of the systems alone. Since the injector of the present invention has two active control valves, coordination of the control schedule between two valves can produce markedly different and desirable injection characteristics. More particularly, the pressure control valve is used to define the window of operation during which the actuation pressure will be used. The timing control valve is responsible within the window for the precise control of injection timing events and duration, such as start of injection, end of injection, timing of interruption and duration of interruption.

The Pilot Injection Process Of The Present Invention Is Accomplished By Controlled Interruption Of A Normal Injection Event.

With the present invention, an injection event, including pilot injection and/or rate shaping, is considered as a single shot injection event, but with a certain duration of interruption. The duration of interruption (dwell) is effected by the timing control valve and is the consequence of dwell. When the interruption (dwell) is short, it results in a rate shaping injection. See FIG. 3, case 5 and FIG. 4, case 5. When the interruption is long, it causes split or pilot injection. See FIG. 3, case 1 and FIG. 4, case 3. Without any interruption, the injection is a normal single shot. See FIG. 3, case 4 and FIG. 4, case 1. But with interruption, depending on the duration of interruption (dwell), the injection flow curve can be formed to provide rate shaping, split injection, pilot injection and more injection segments as needed. This controlled interruption to a normal injection event can happen any time during the injection event as long as actuation pressure or injection pressure exists.

Independent Control of Pilot Injection and Main Injection Within a Single Shot Injection Event.

All present unit injection systems need to achieve pilot injection and main injection by generating two independent single shot injection events. For example, the injection system described in U.S. Pat. No. 5,460,329 requires the decay of actuation pressure to define between the pilot and main injection events. In the prior art, this may be accomplished by reversal of the motion of the intensifier. Such reversal has the disadvantage of diminishing the injection pressure in the fuel injector. Once the injection pressure is developed in the fuel injector during an injection event, the injection pressure should not be destroyed for the purpose of pilot injection pressure, if possible. The total time allowed for injection to occur is too short to waste in diminishing and rebuilding injection pressure. Therefore, the concept of the present invention is to emphasize no reverse motion of the intensifier piston and plunger during pilot injection, thereby maintaining injection pressure. Dwell in the pilot injection is caused by closing the needle valve rather than by reducing or eliminating the injection pressure. The timing control valve of the present invention is used to spill part of the high pressure fuel to the back of the needle valve to force needle valve closing. This closing creates the separate pilot and main injection events while maintaining injection pressure in the injector.

The Present Invention Improves The Digital Control Valve HEUI Injection System (U.S. Pat. No. 5,460,329), Making It More Efficient In Main Injection Pressure And Shorter In Duration.

This improvement is achieved in the present invention by having main injection occur under maximum injection pressure situation. Maximum injection pressure is obtained by having the full actuation pressure level acting on the intensifier piston at all times during the injection event. The intensifier chamber pressure is maintained at maximum actuation pressure, since the pressure control valve stays open all the time throughout the injection event, i.e., the plunger chamber fuel pressure then is maintained at maximum intensified level. There is no double action of the pressure control valve as in the past.

Improved Response in Shaping the Injection Event as Desired.

In the present invention, the pressure control valve is much larger (in terms of flow area) than the timing control valve and is therefore much less responsive than the timing control valve. This is because the flow rate of actuation liquid is about seven times more than the fuel injection flow rate. Therefore, with the concept of the present invention, the large pressure control valve is only operated once per injection event while the small timing control valve can be operated multiple times if needed during an injection event in order to effect the desired rate-of-injection shape. This is evident in reviewing the valve positions depicted in cases 1-5 of FIG. 4. The relatively small timing control valve has much better response than the relatively larger pressure control valve.

More Varied Injection Characteristics Are Achieved With The Two Active Control Valves Of The Present Invention In One Unit Injector Of The Intensifier Type Than Can Be Achieved With A Single Control Valve.

No present fuel injection system is able to generate all the noted flexible injection characteristics without introducing significant variability from injection event to injection event and deterioration of performance. Most production injectors can only do some of the features listed in FIG. 3. All of the FIG. 3 features are attainable by the present invention. It is highly desirable that a unit injector be able to do all of these features in order to meet high emission standards, reduced noise, and improved drivability.

The present invention includes a needle valve controller for use in a fuel injector to control the opening and closing of a fuel injector needle valve, including a selectively actuatable timing control valve being in flow communication with a source of fuel under pressure and being in flow communication with a fuel injector needle valve surface, the valve being shiftable between an open and a closed disposition. A controller is operably coupled to the timing control valve for controlling the shifting of the timing control valve between the valve open and closed dispositions, opening of the timing control valve acting to port fuel under pressure to the fuel injector needle valve surface, the fuel generating a force on the fuel injector needle valve surface acting to close the fuel injector needle valve.

The present invention is further a method of defining a fuel injection event in a fuel injector having a fuel pressure intensifier, including the steps of (a) preparing fuel pressure with a fuel injection pressure control valve, and (b) controlling the timing of a fuel injection event with a fuel injection timing control valve, the fuel pressure preparation and the timing of the fuel inject event being independently controllable.

### BRIEF DESCRIPTION OF THE DRAWINGS

FIG. 1 is a sectional side view of the prior art HEUI injector;

FIG. 2 is a sectional side view of a HEUI-type injector with the needle valve control of the present invention;

FIG. 2a is an enlarged depiction of the area 2a of FIG. 2 in the closed disposition;

FIG. 2b is an enlarged depiction of FIG. 2a in the open disposition;

FIG. 3 is a series of graphic depictions of injection features attainable by the present invention;

FIG. 4 is a series of graphic depictions of the effects of different coordination between the injection control valve and the timing control valve and the resulting rate of injection;

FIG. 5 is a graphic depiction of pilot and dwell control parameters;

FIG. 6 is a graphic depiction of the performance characteristic;

FIG. 7 is a sectional side view of a further embodiment of the invention incorporating piezo controlled direct needle actuation with the needle valve in the closed position;

FIG. 8 is a sectional side view of a further embodiment of the invention incorporating piezo controlled direct needle actuation shown in FIG. 7 with the needle valve in the open position;

FIG. 9 is yet a further embodiment of the invention utilizing a known direct needle control system;

FIG. 10a is yet a further embodiment of the invention utilizing yet another known direct needle control system with the needle valve in the closed position; and

FIG. 10b is yet a further embodiment of the invention utilizing the direct needle control system shown in FIG. 10a with the needle valve in the open position.

### DETAILED DESCRIPTION OF THE PREFERRED EMBODIMENT

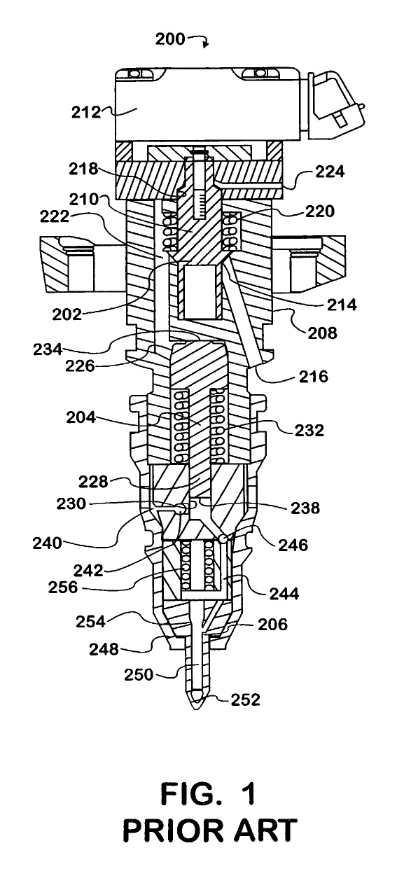

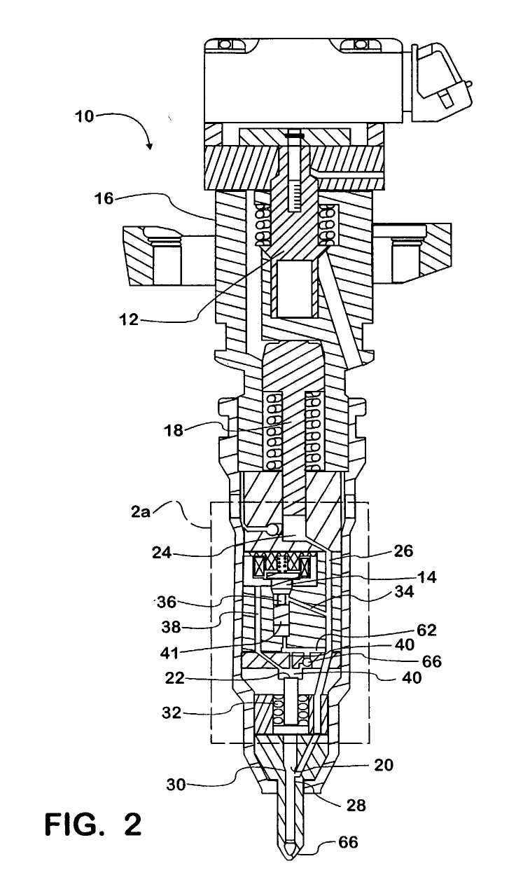

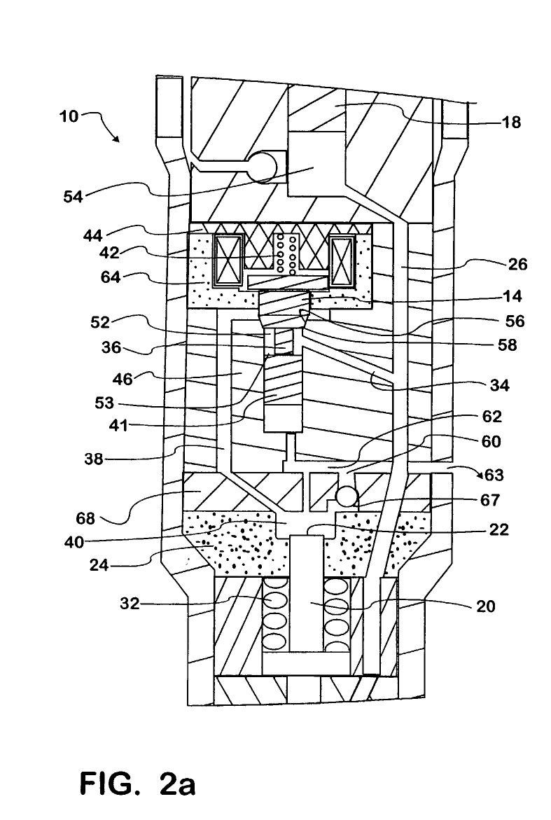

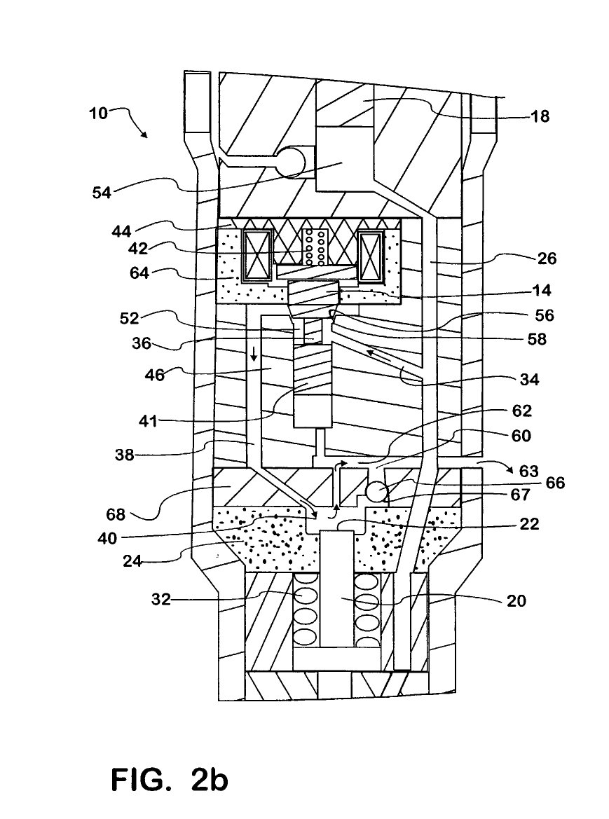

FIG. 2 shows the injector 10 of the present invention. The HEUI injector 200 is used as the baseline injector, as depicted in prior art FIG. 1, and has been modified to incorporate the present invention. Other intensifier type injectors may be utilized to incorporate the present invention. The injector 10 of the present invention has two active control valves. The first control valve (the pressure control valve 12) is on the actuation liquid side and the second control valve (the timing control valve 14) is on the high pressure fuel side.

The injector body 16 contains the injection pressure control valve 12, a pressure intensifier 18, the timing control valve 14, and a spring loaded conventional needle valve 20 disposed in the injector tip housing 21 of the injector 10. The timing control valve 14 and associated fluid passageways (as will be discussed below) of the present invention are included for direct hydraulic control of the needle valve 20. As will be described in more detail below, the basic function of the timing control valve 14 is to pass high pressure fuel to the needle valve control surface 22 of the needle valve 20. Such fuel acts on the needle valve control surface 22 to accurately, directly, and hydraulically control the opening and closing motions of the needle valve 20 as desired to effect desired injection characteristics.

There are two flow passageways from the bottom of the plunger chamber 24 to needle valve 20. High pressure fuel passageway 26 is conventionally connected to the nozzle chamber 28 where the needle front area 30, formed by an increased diameter of the needle valve 20, is exposed to the fuel pressure. Fuel pressure generated in the chamber 28 acts upwardly on the front area 30 to open the needle valve 20 by opposing the closing bias of the needle valve spring 32.

The first bleed off passageway 34 is fluidly coupled to the spool 36 of the timing control valve 14. A second bleed off passageway 38 is fluidly coupled to the spool 36 and is further fluidly coupled to a chamber 40 defined in part by the needle valve control surface 22 of the needle valve 20. In a preferred embodiment, surface 22 is a top margin at the back of the needle valve 20.

FIGS. 2a and 2b show the enlarged timing control valve 14 and the relation to the high pressure fuel passage 26. The timing control valve 14 includes a coil spring 42, an end cap 44, a valve body 36, and the valve housing 46. Leakage between the timing valve body 36 and the housing 46 is preferably controlled to a minimum. There is a spool groove 52 on the valve body 36 which defines in part the spool chamber 53. The spool chamber 53 provides flow communication between the intensifier chamber 54 to the chamber 40 at the needle back when the control valve 14 is in the open position. A sealing portion 41 of the valve body 36 depends from the groove 52.

The timing control valve 14 is a simple open(on)/closed(off) two position valve, FIG. 2b being a depiction of the open(on) configuration of the timing control valve 14 and FIG. 2a being a depiction of the closed(off) configuration of the timing control valve 14.

When the timing control valve 14 is at its off position (FIG. 2a), chamfered valve face 56 is seated on the valve seat 58 and fuel flow through the spool chamber 53 from the first bleed off passageway 34 to the second bleed off passageway 38 is blocked. The fuel flow to the chamber 40 via second bleed off passageway 38 at the back of the needle valve 20 is accordingly also blocked. The chamber 40 is vented to an external low pressure fuel reservoir 63 (depicted schematically in the figures) through the needle back drain orifice 60 and through the drain passageway 62. Drain passageway 62 is preferably in a different plane as the section and is therefor shown in phantom in FIGS. 2a and 2b. It should be emphasized that the drain passageway 62 is not fluidly coupled to the high pressure fuel passageway 26.

Drain passageway 62 is drained to the fuel reservoir 63 located external to the injector 10. The fuel reservoir 63 is typically at the pressure (about 50 psig) generated by the engine fuel pump. Drain orifice 60 is relatively restrictive, (preferably between 0.1 and 1.0 mm and more preferably less than 0.5 mm in diameter), having a very small cross-sectional area, and is preferably allowed to flow in both directions (to and from the fuel reservoir 63).

A one way ball check valve 66 is placed in a refill passageway 67 extending between the chamber 40 and the drain passage 62 to the fuel reservoir 63. The check valve 66 is controlled by fuel pressure. When pressure in chamber 40 exceeds pressure in passageway 62, check valve 66 is seated against valve seat 67. Accordingly, fuel flow through check ball 66 is blocked when the chamber 40 is pressurized by the high pressure fuel admitted by the timing control valve 14 and is also blocked during the opening motion of the needle valve 20. The check valve 66 permits sufficient refilling of fuel (at 50 psi) from the fuel reservoir 63 to the chamber 40 to accommodate the volume change in chamber 40 which occurs during the closing motion of the needle valve 20.

The injector 10 acts just like the prior art HEUI injector 200 when the timing control valve 14 is in the closed configuration as described in FIG. 2a. Such action is noted above in the background section.

Opening of the timing control valve 14 is effected by a solenoid 64. When the current is supplied to the solenoid 64, the timing control valve 14 moves upward against the spring load of the timing valve spring 42 to the full open position of the timing control valve 14. See FIG. 2b. In this open position, the high pressure fuel passage 26 is fluidly connected to the second bleed off passageway 38 through the spool chamber 53 defined by the spool groove 52. High pressure fuel is bled off from plunger bottom chamber 54 to the chamber 40 at the back of the needle valve 20. In this open position, bleed passageways 34, 38 are fully open and the chamber 40 is pressurized. The pressure acts on the surface 22 in conjunction with spring 32 to prevent upward, opening motion of the needle valve 20 or to close the needle valve 20 if the needle valve 20 is open at the time that the timing control valve 14 is opened. Therefore, the needle valve 20 is in the closed position when the timing control valve 14 is in the open position. If the timing control valve 14 stays in the open position for some period of time during an injection event, a measurable duration of the needle valve 20 being closed after injection event initiation is obtained. The needle valve 20 closing duration may be equal to the dwell of the pilot injection event.

The drain orifice 60 is open all the time, but the drain orifice 60 has a very small flow area in order to throttle down fuel flow through the drain orifice 60. Therefore, when high pressure fuel flows into the chamber 40, sufficient pressure is trapped in the chamber 40 to cause needle valve 20 closing by the fuel pressure generating a force acting on surface 22 of the needle valve 20 (in conjunction with spring 32). A constant through-flow occurs at the orifice 60 when timing control valve 14 is in the open position (FIG. 2b). (This is very similar to the common rail type system, in which constant leakage of high pressure fuel occurs during the whole injection process.) During a regular single shot injection, the timing control valve 14 is never used and the drain orifice 60 slows down lifting of the needle valve 20 slightly due to the restriction of the drain orifice 60 in permitting fuel to escape from the chamber 40 to the fuel reservoir.

Bleeding off high pressure fuel to the chamber 40 by opening timing control valve 14 causes the needle valve 20 to close if the needle valve 20 is in an open condition. If the timing control valve 14 is open at the very beginning of the injection event (the condition where the intensifier plunger 18 is just about to move downward to increase the fuel pressure), the needle valve 20 will stay in a closed position regardless of what happens to the injection pressure due to the fuel pressure generating the force acting on the surface 22 of the needle valve 20. This can cause a delayed start of injection into the combustion chamber, as desired.

With this strategy, the user can selectively choose the starting condition of each injection event since needle valve 20 opening pressure is controlled by the timing control valve 14. If the timing control valve 114 is opened after injection has already started, an interrupted injection event occurs due to a sudden closing of the needle valve 20. The sudden closing of the needle valve 20 is effected by the opening of the timing control valve 14 to port high pressure fuel to chamber 40. This is pilot injection and results in dwell (a definitive elapsed time occurring) between the pilot injection and the main injection during which no fuel injection is occurring. If the timing control valve 14 is opened at end of the injection event, the timing control valve 14 will cause the needle valve 20 to close even before the pressure control valve 12 is turned off. This produces a sharp end of the injection event, as desired.

The opening/closing of the needle valve 20 is directly controlled by the timing control valve 14. Therefore, this concept is called direct-controlled needle valve and is similar in this regard to a common rail system, having needle valve 20 closing to shape and control the rate of injection, to end pilot injection and form dwell although injection pressure.

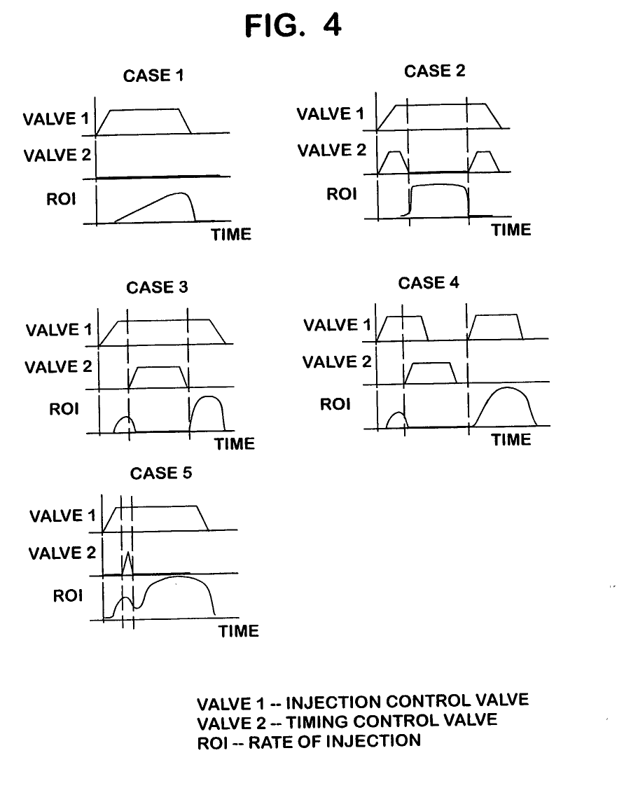

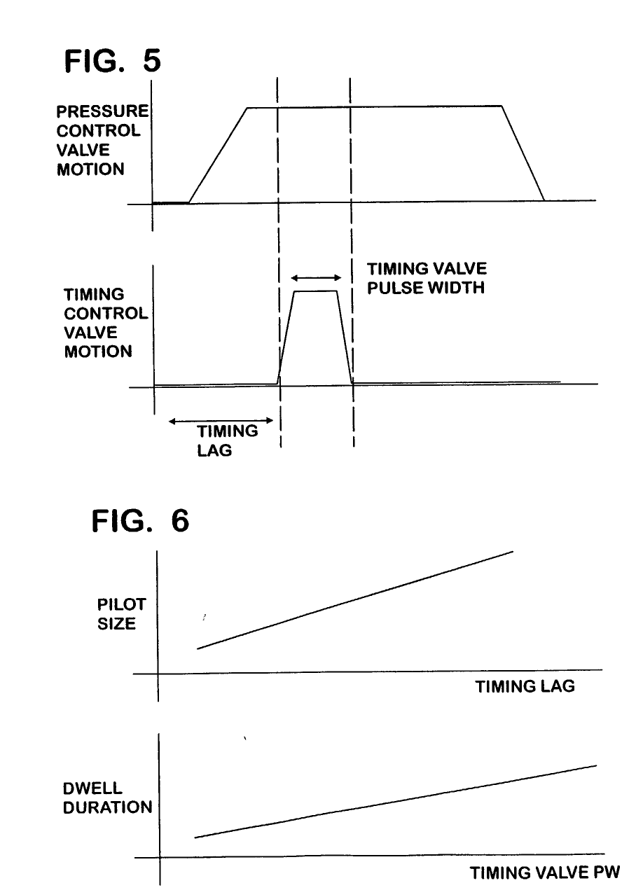

Referring to FIGS. 5 and 6, during pilot injection, if the timing control valve 14 stays in the open position for a relatively long duration, it produces longer dwell as described above. If the timing control valve 14 stays in the open position for a relatively short duration, a closed pilot injection (no dwell) or rate shaping of the injection event occurs, affecting the shape of the ascending portion of the rate of injection of the injection event.

During the period when the timing control valve 14 is open, the needle valve 20 is closed and the intensifier plunger 18 may continue to move downward due to leakage at the drain orifice 60 from chamber 40 at needle valve 20. The drain orifice 60 is open to the fuel reservoir (approximately 50 psi). Since the drain orifice 60 is very small, the leakage flow from chamber 40 is relatively small. Injection pressure is maintained and the downward compressive motion of the intensifier 18 continues even during temporary shut off of nozzle fuel flow to the combustion chamber from the needle valve 20. This is as a result of the timing control valve 14 being open to exert pressure on surface 22 of needle valve 20. The injection process efficiency is improved by such method of producing dwell by maintaining the injection fuel pressure at a high level throughout the full injection event, instead of decreasing the pressure as a result of reversing the motion of the intensifier 18 in order to shape the rate-of-injection, as in some prior art injectors.

Sizing of the needle drain orifice 60 is very important. The needle drain orifice 60 is open to low fuel pressure (approximately 50 psi) through passageway 62 to the fuel reservoir 63 all the time. With the right size orifice 60, sufficient fuel pressure can be trapped in the chamber 40 to act on surface 22 of the needle valve 20 when high pressure fuel flows from plunger chamber 54 to the chamber 40 as a result of opening the timing control valve 40. The drain orifice 60 allows back pressure in chamber 40 to release slowly when bleed flow into the chamber 40 is stopped. Slow bleed flow at the drain orifice 60 helps to adjust and control the lifting velocity of the needle valve 20 to meet preselected requirements. The size of the drain orifice 60 is very critical to keep the needle valve 20 closed when the timing valve 14 is open, to prevent an excess amount of high pressure fuel from leaking through the drain orifice 60, and to have a slow drain flow at the orifice 60 when the needle valve 20 lifts up again (after fuel pressure bleed off from chamber 40 through orifice 60). The size of the drain orifice 60 is optimized to the needs of the particular injector 10 and the diameter is preferably about 0.1 mm-1.0 mm. In a preferred embodiment, the drain orifice 60 is about 0.5 mm or less. The volume of fuel acting on the surface 22 of the needle valve 14 is partially trapped in the chamber 40 having a volume defined by the needle back 22, the needle housing 24, and check ball plate 68. The needle back surface area 22 is sized properly so that force generated by fuel pressure on the back of the needle valve 20 plus needle spring force exerted by spring 32 is greater than the countering force generated by the high pressure fuel acting on needle front 30. Such force on needle front 30 acts counter to the force of the fuel pressure acting on surface 22 in conjunction with the bias of spring 32. Proper sizing of surface 22 with regard to the surface of needle front 30 and the bias exerted by spring 32 ensures proper closing of the needle valve 20 when the timing control valve 14 is open. This sizing is important since the high pressure fuel is simultaneously to both open and close needle valve 20.

Since the total flow required to the chamber 40 at the needle back is very small, the necessary size of the timing control valve 14 is much smaller than the pressure control valve 12. Further, the travel distance of the timing valve 14 (valve total opening) is also much smaller than the travel (valve total opening) distance of the pressure control valve 12. Therefore, the response of the timing control valve 14 is much faster than the response of the pressure control valve 12.

During the dwell period of a pilot injection event, there is a constant bleeding of high pressure fuel through the needle drain orifice 60. Thus, the intensifier plunger 18 may drift down slowly replenishing fuel in chamber 40 that has been bled from the chamber 40 whenever the timing control valve 14 is in the open configuration. If the timing control valve 14 was open for a duration that is very long, the intensifier plunger 18 could bottom out. This risk is avoided by sizing the stroke of plunger 18 properly, and also by coordinating both the timing control valve 14 on and off schedules properly to avoid an overly long dwell.

A flexible injection system should have the capability to do single shot injection mode, detached pilot injection mode, attached pilot injection mode, and rate shaped injection mode. The following section describes the operation procedure of the present invention for each different operation modes.

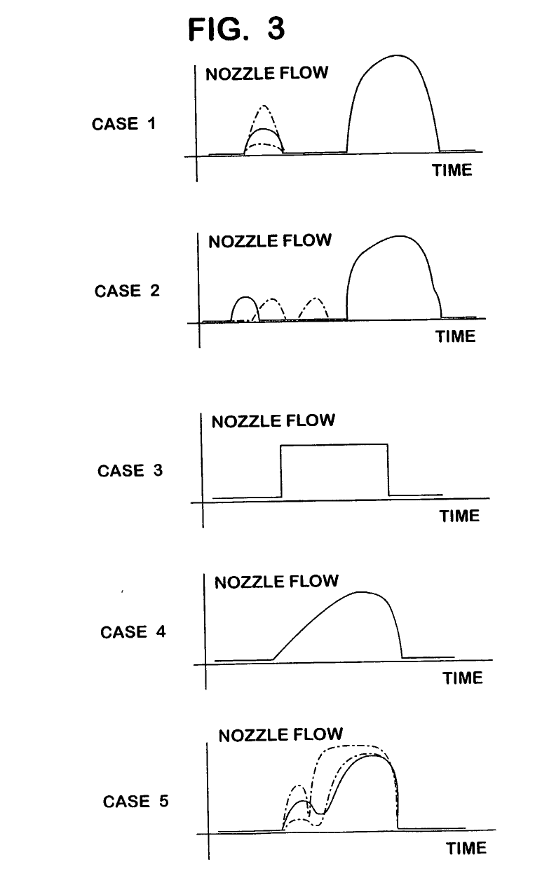

Single Shot Injection With Triangle or Ramp Shaped Injection (FIG. 4, Case 1: FIG. 3, Case 4)

During single shot ramp injection, the timing control valve 14 stays in the closed position and is never used throughout the injection process. Therefore, high pressure fuel flows only to the front or lower side of the needle valve 20 while the chamber 40 is never pressurized and is vented through drain orifice 60 and passageway 62 to the low fuel pressure reservoir 63. Both timing and injection duration are controlled by the actuating pressure control valve 12. When the pressure control valve 12 is opened, injection pressure builds up gradually in the high pressure fuel passageway 26. The high pressure fuel acts on needle front 30, overcoming the bias of spring 32 and lifting (opening) the needle valve 20. When needle valve 20 opens, injection starts. The resulting single shot injection is substantially the same as a normal prior art HEUI injector 200 injection event as described above in relation to prior art FIG. 1.

Single Shot Injection With Square Fuel Pressure Shape (FIG. 4, Case 2; FIG. 3, Case 3)

Operation of both the control valves 12, 14 is required to achieve a square rate of injection characteristic. The timing control valve 14 is opened ahead of or at the same time that the actuating fluid pressure control valve 12 is opened. A spill and bypass concept is used in this instance to bleed off the initial portion of the fuel pressure buildup resulting from actuation of the actuating pressure control valve 12 to thereby delay the injection starting. Opening the timing control valve 14 results in a spill and bypass through chamber 40, drain orifice 60 and passageway 62 to the low pressure fuel reservoir 63. The initial portion of the injection pressure is relatively low, so injection occurring under this initial portion would cause ramp shaped injection (like single shot ramp injection) if the timing control valve 14 were closed. However, the timing control valve 14 is opened here to bypass these undesired initial pressure conditions and to allow the needle valve 20 to wait to open until the more desirable higher pressure level is attained.

The initial portion of the pressurized fuel is bled off to chamber 40. Because the pressure of the fuel in chamber 40 acts on the surface 22, the force exerted by the fuel pressure in conjunction with the bias exerted by the valve spring 32 acts to keep the needle valve 20 closed. Therefore, the needle valve 20 will stay closed until the timing control valve 14 is returned to the closed position by spring 42 after deactivation of solenoid 64. After a desired period, deactivation of solenoid 64 occurs and valve 14 returns to the closed position. At this time, the injection fuel pressure will have already developed to a very high level. Since the pressure control valve 12 is at fully open position and the intensifier 18 downward velocity has developed, injection occurring under this condition is eruptive and has a very fast rate of injection at the beginning of the injection event. Meanwhile a constant injection pressure is maintained at the plunger chamber 24 by the intensifier 18. This pressure equals the rail pressure of the actuating fluid times the intensification ratio of the intensifier 18. The rail pressure of the actuating fluid may be approximately 3000 psi. The intensification ratio may be seven, resulting in fuel pressure of approximately 21,000 psi.

At the end of injection, the timing control valve 14 is cycled to the open position again by activating solenoid 64 to overcome the closing bias of timing valve spring 42 before the actuating fluid pressure control valve 12 is closed. After opening of timing control valve 14, the fuel pressure of the fuel in chamber 40 again acts on the surface 22. The force exerted by the fuel pressure on the surface 22 in conjunction with the bias exerted by the valve spring 32 acts to forcibly, abruptly close the needle valve 20. Injection flow is nearly instantaneously cut off to zero by this forced closing of the needle valve 20, rather than the more gradual needle valve 20 closing caused by actuation fluid injection pressure decay, as in the prior art. Therefore, the end of injection is also very sharp, resulting in the desired, generally square fuel pressure shape.

Pilot Injection With Reasonable Dwell Duration (FIG. 4, Case 3, FIG. 3, Case 1 (Solid Line))

With the present invention, pilot injection is considered as a single shot injection fully interrupted for a certain duration prior to the main injection, which is also a single shot injection separate from the pilot injection. This interruption is caused by a sudden closing of the needle valve 20 by the timing control valve 14 some time after commencement of the injection event as initiated by the pressure control valve 12. If needle valve 20 closing duration is relatively long, the dwell between pilot injection and main injection will be long. Since both control valves 12, 14 are independently controlled, the on/off schedules of both valves 12, 14 are totally flexible and do not have any interaction and interference with each other. Just as in the case of single shot injection event, in this case the pressure control valve 12 is actuated only once to open the pressure window to the intensifier system 18. The timing control valve 14 is initially closed when the pressure control valve 12 is opened. After the pressure control valve 12 is open, the needle valve 20 opens by lifting upward and injection will start as indicated above in relation to the single shot injection case. The timing valve 14 is then moved to the open position soon after the pressure valve 12 is opened by activation of the solenoid 64. The needle valve 20 then closes again responsive to the timing valve 14 being open, resulting in cessation of the injection. Prior to the closing of the needle valve 20, a small amount of fuel has escaped to the combustion chamber of the cylinder from nozzle hole 66. This produces pilot injection, a very small quantity of injected fuel over a short duration separate in time from the main injection event. The independent pressure control valve 12 remains open and fuel pressure is maintained in a high state.

The size of the pilot injection is clearly the function of the timing lag between the opening of two valves 12, 14. The longer the lag is, the larger the pilot injection volume will be. Since both valves 12, 14 are independently controlled, the pilot injection volume is controlled in a very simple and flexible way. The timing valve 14 may stay open for a while corresponding to the size of the pilot injection dwell duration. At the end of the dwell, the timing valve 14 is turned off again. This results in the opening of the needle valve 20 and the injection event is resumed, providing the main injection event spaced in time from the pilot injection event. The intensifier 18 continues to travel downward in order to provide a continual quantity of high pressure fuel to finish the main injection. The end of injection is accomplished by turning off the pressure control valve 12.

The end of injection can also be achieved by opening the timing control valve 14 to have a forced closing of the needle valve 20 before the pressure control valve 12 turns off. This produces a sharp end of injection as described above in the case of single shot injection with square fuel pressure shape. Thus, the needle valve 20 closes before the decay of injection pressure resulting from closing the pressure control valve 12.

Pilot Injection With Very Long Dwell Duration (FIG. 4, Case 4)

When the dwell duration is extremely long, then pilot injection can be considered as two individual single shots effected by cycling the pressure control valve 12 through two open/close cycles. The pressure control valve 12 is turned on first to start the injection. Since pilot portion has very small total delivery, the timing valve 14 may be used to interrupt the injection commenced by the pressure control valve 12 and to prevent the needle valve 20 from being open too long. After the pilot injection is stopped, the pressure control valve 12 may be turned off to finish the first single shot event. Pressure on top of the intensifier 18 is vented to ambient and the intensifier 18 returns to the top closed position waiting for next injection event. The venting passage (not shown) is conventionally located at top of the poppet valve immediately above the poppet valve spring. To commence main injection, the pressure control valve 12 is opened again and a second injection event starts. Depending on the engine needs, either ramp, single shot, or squared single shot strategy can be used to produce a single shot as the main injection event by appropriate interaction of the timing valve 14 with the pressure valve 12.

Rate-Shaped Injection (FIG. 4, Case 5, FIG. 3, Case 5)

The operation strategy for rate-shaped injection is almost the same as for pilot operation (reasonable dwell case), FIG. 4, case 3. In rate shaped injection events, the timing control valve 14 “on” time is very short, for example, the minimum controllable pulse width of the timing control valve 14. With a very short interruption from the timing control valve 14, the needle valve 20 may not fully return to the closed position during the on time of the timing control valve 14. Injection pressure is only interrupted for a very short period in such case. Therefore, the rate of injection trace will not be split into segments as in FIG. 4, case 3 but will not decay to a zero rate of injection condition. This results in a classic dipped rate-shaped trace.

Depending on the timing control valve 14 schedule, a different rate-shaping trace can be obtained. See FIG. 3, case 5. The rate-shaping injection is considered to be a single shot injection with a very small interruption at an early stage of the injection.

Some of the novel features of the present invention are categorized into two areas: (1) design configuration and (2) injection operation.

(1) Design Configuration

Two active, independently controlled, control valves 12, 14 are used in one unit injector 10. The pressure control valve 12 is on the actuation fluid side to open the pressure window for injection events. Without turning on the pressure control valve 12, there will be no injection pressure, hence no injection, regardless of what happens to the timing control valve 14. The timing control valve 14 is placed on the high pressure fuel side (as distinct from the actuation fluid side) to achieve direct control of the needle valve 20 substantially independent of the pressure control valve 12. Thus, an injection event is stopped or interrupted when the timing control valve 14 is turned on, the timing control valve 14 being on acting to close the needle valve 20. Additionally, because the timing control valve 14 is on the fuel side, continued operation of the intensifier plunger 18 occurs under control of the pressure control valve 12 to ensure a continuous source of high pressure fuel.

(2) Injection Operation

A unit injector 10 with two active control valves 12, 14 does not exist in production today. Therefore, the strategy based on a coordinated schedule of operation of the two control valves 12, 14 is new to the industry.

It is very difficult for a unit injector 10 with a single control valve 12 to produce a variety of injection characteristics (such as those shown in FIG. 3) while still maintaining sufficient controllability, flexibility and simplicity. The control strategy of the present invention presented in the operation procedure section illustrates how two control valves 12, 14 can be coordinated to each other's on/off timing and duration to obtain the varieties of injection characteristics depicted in FIG. 3.

As fuel injection systems are getting more and more sophisticated in terms of operation and control, it becomes more important to design an injector that not only provides excellent performance but also has user friendliness, simplicity and robustness in control strategy. FIGS. 5 and 6 illustrate the relationship between control parameters and performance parameters of the present invention. The injection system of the present invention has two active control valves 12, 14. The valves 12, 14 do not interfere with each other and each valve 12, 14 has very clear responsibility.

FIG. 5 shows the definition of timing lag and timing valve pulse width (PW). Timing lag is the time duration between the start of the pressure control valve pulse width to open the valve and the start of the opening of the timing control valve. Timing lag is an indication of how much later the timing control valve 14 may be actuated on to interrupt the injection event initiated by the pressure control valve 12. Timing lag is also a indication of the pilot injection quantity which will escape from the nozzle before the needle valve is forced to close. Therefore, the pilot injection quantity is linearly related to the timing lag parameter as shown in FIG. 6. The timing control valve 14 pulse width duration is the indication of how long the timing control valve 14 would stay in the open position. Since the timing control valve 14 opening directly causes needle valve 20 closing, the timing control valve 14 pulse width is linearly proportional to the amount of time the needle valve 20 will stay closed. Therefore during pilot injection, dwell is linearly related to the timing control valve 14 pulse width as shown in FIG. 6.

A major advantage of the fuel system of the present invention is that it incorporates the advantage of both the intensifier injection system and the common rail injection system. It is a marriage of the two systems, while avoiding some of the disadvantages of each of the two systems.

(1) The injector 10 advantageously does not require high pressure fuel transporting as does the common rail system. High injection pressure is contained within the unit injector. The unit injector 10 is exposed to high pressure operation only during injection event. This is the advantage of the intensifier system.

(2) The injector 10 has direct control of the needle valve 20. This feature is very critical to pilot injection operation. Without direct needle valve 20 control, a small pilot and a small dwell can not be achieved. Direct needle valve 20 control is the advantage of the common rail system as distinct from the intensifier system. This advantage is also kept with the present invention.

(3) Decoupling the actuating fluid pressure control event from the needle timing event as provided for with the present invention makes the whole injection operation much simpler, more flexible and more controllable. Each control valve 12, 14 has its own substantially independent responsibility. The two control valves 12, 14 do not interact and can be controlled independently. This indicates the simplicity of the control strategy. Results can be easily interpolated and extrapolated.

(4) With the present invention, a wide variety of all desired injection characteristics can be readily achieved. No injector in production today is able to achieve all the features. The common rail system cannot achieve ramp injection and rate shaping. The HEUI intensifier system cannot achieve square injection. Pilot size and dwell range are also limited in the prior art.

(5) The philosophy behind this invention is very different from the conventional approach. In this concept, the pilot and rate shaping injections are considered as a single injection interrupted for a short period. Based on this philosophy, each control valve 12, 14 is assigned a sole responsibility coordinated with the other control valve 12, 14. The larger pressure control valve 12 only operates once to perform the single shot injection. The smaller and faster timing control valve 14 can be used many times to control the needle opening and closing during a single open cycle of the pressure control valve 12.

(6) This injector 10 has an intensifier. However, the injector 10 does not require reversal of the intensifier 18 motion to stop pilot injection. This is different from the HEUI-B and digital valve HEUI injection concepts. By avoiding reversal of the intensifier 18 motion, the hydraulic efficiency of the injection is significantly improved, by maintaining high fuel pressure throughout an injection event, even during an injection event having a pilot injection spaced in time from the main injection.

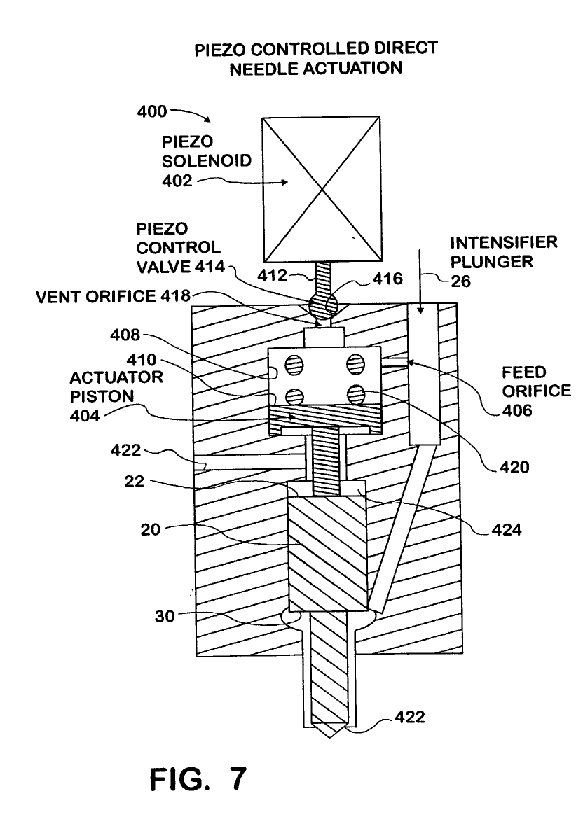

### The Embodiments of FIGS. 7-10b

The principles put forth in the present application apply more generically to the concept of mating direct needle valve control with an intensifier type of pressure fuel generation of an appropriate level (approximately 1,500-1,600 bar) for injection into the combustion chamber of a diesel engine. It has been noted that there are certain advantages to what is termed a common rail fuel injection system. Such a system is produced by Robert Bosch GmbH and was recently chosen to provide the injection for the General Motors Duramax 6600 V8 diesel engine. It has been stated that the common rail system was chosen for this engine to meet the trend in evermore stringent exhaust emission regulations and for the following advantages:

High pressure injection capabilities (it should be noted that, while the authors of the paper profess this as a reason for selecting the system that they did, in fact, the intensifier system described with reference to the above embodiment of the present invention gives higher injection pressure than the common rail system); and

Flexibility of injection parameters (including variable injection timing, pilot injection, main injection, post injection, and variable injection pressure).

See Society of Automotive Engineers Paper, 2000-01-3512, The New Common Rail Fuel System for the Duramax6600 V8 Diesel Engine, authored by Ohishi et al, and incorporated herein by reference. The main characteristic of the Bosch common rail system is its constant injection pressure of 1600 bar. While those that selected the common rail system for application in this engine appreciated the flexibility of injection parameters afforded by the common rail system, this flexibility is not without penalty. As stated in the above SAE paper, “ . . . durability is required of the common rail system. To achieve 1600 bar compatible with an extended life, numerous modifications and new technologies were applied.” An approach to avoiding the complexity implicitly encountered by the designers of the common rail system for the Duramax 6600 diesel engine is to avoid the high pressure common rail altogether by generating the injectable fuel pressures within the injector itself using the intensifier system of the HEUI type injector coupled with a suitable direct needle valve control as put forth above.

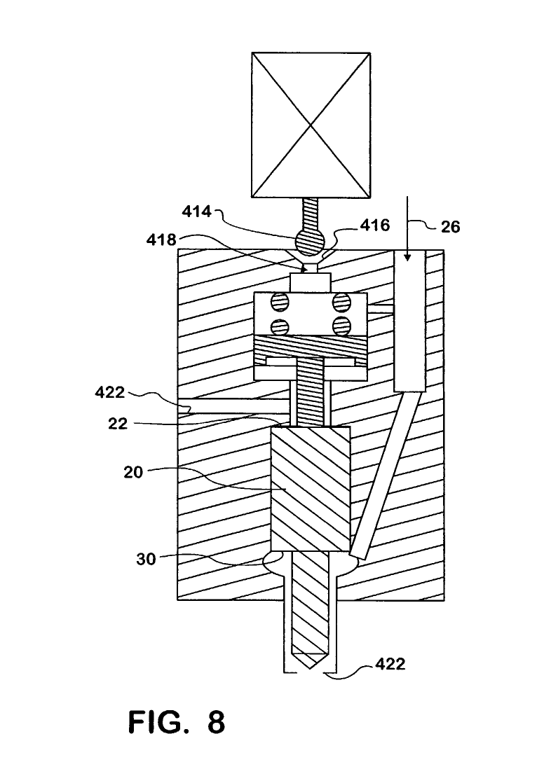

Accordingly, a first further embodiment of the present invention is then coupling the HEUI intensifier of FIG. 2 with a piezo controlled direct needle actuation. Piezo controlled direct needle actuation is depicted in FIGS. 7 and 8 and is put forth in greater detail in U.S. Pat. Nos. 5,875,764 to Kappel et al., and 6,062,533 to Kappel et al., both patents being incorporated herein by reference. In this embodiment, the pressure control valve 12 and intensifier 18 of FIG. 2 are mated to the piezo controlled direct needle actuation of FIGS. 7 and 8. Such mating is effected by coupling the high pressure fuel passageway 26 to the piezo controlled direct needle actuation system. Such coupling is noted in FIGS. 7 and 8 as being “flow from intensifier plunger”.

Piezo controlled direct needle actuation has the characteristic of relatively faster acting, hence better response time as compared to the solenoid pressure control valve 12 of the HEUI injector acting alone. The motivation behind the present invention is to use this piezo high speed response to directly control the needle valve to use the intensifier pressure generation device of the HEUI injector to develop high injection fuel pressure to supply needle valve flow demand. Combining the piezo controlled direct needle actuation with the HEUI intensifier type pressure generation is an enhancement of the prior art HEUI injector as depicted in FIG. 1. The piezo controlled direct needle actuation is shown generally at 400 in FIGS. 7 and 8.

In operation, the piezo controlled direct needle actuation 400 includes a piezo solenoid 402, a control valve actuator piston 404 bearing directly on the needle back 22 of the needle valve 20. A feed orifice 406 fluidly couples the high pressure fuel passageway 26 to the actuator chamber 408. The area of the actuation piston head 410 is greater than the front area 30 of the needle valve 20. This relationship is important to operation of the piezo control direct needle actuation 400.

The feed orifice 406 has a relatively small area such that the feed orifice 406 has a throttling function. Accordingly, pressure loss occurs when high pressure fuel flows from the high pressure fuel passageway 26 through the feed orifice 406.

The piezo solenoid 402 translates between a closed position depicted in FIG. 7 and an open position depicted in FIG. 8. The piezo control direct needle actuation 400 includes a piston 412 coupled to the piezo solenoid 402. The piston 412 is operably coupled to a ball control valve 414. The ball control valve 414 is seatable in a seat 416. The seat 416 is operably coupled to a vent orifice 418. The vent orifice 418 is in fluid communication with the chamber 408.

In the closed position as depicted in FIG. 7, the ball control valve 414 is seated on the seat 416, thereby sealing off the vent orifice 418. High pressure fuel admitted through the feed orifice 406 is then present in the actuation chamber 408. Pressure in the actuation chamber 408 is substantially balanced with the pressure in the high pressure fuel passageway 26 and in the plunger chamber 24 (see FIG. 2) of the intensifier 18. The high pressure fuel is also acting on the front area 30 of the needle valve 20. In this condition, fuel pressure acting on the head 410 of the actuator piston 404 in combination with the bias exerted by the spring 420 is greater than the opposing force generated on the front area 30 (the front area 30 being less than the area of the head 410). The needle valve 20 is held in the closed disposition and, accordingly, the injection orifice 422 is sealed off the by the closed needle valve 20. No fuel injection occurs.

The position of the needle valve 20 is controlled by the pressure differential between the pressure exerted on the needle front area 30 and the pressure exerted on the head 410 of the actuator piston 404 (in combination with the bias exerted by the spring 420). Referring to FIG. 8, the ball control valve 414 is raised off the seat 416 by action of the piezo solenoid 402. The unseating of the ball control valve 414 opens the vent orifice 418 allowing the discharge of high pressure fuel from the actuation chamber 408 to a relatively low pressure environment, preferably ambient or near ambient (approximately 50 psi). When the ball control valve 414 is in the open position, fuel pressure in the actuation chamber 408 is much lower than the pressure of the fuel in the high pressure fuel passageway 26 due to leakage flow through the vent orifice 418 and the throttle effect of the feed orifice 406. In this condition, the fuel pressure acting on the needle front area 30 is substantially greater than the fuel pressure acting on the head 410 of the actuator piston 404, in combination with the bias exerted by the spring 420. The very high pressure fuel acting on the needle valve front area 30 generates a force in opposition to the force exerted on the head 410 in combination with the bias exerted by the spring 420 to cause the needle valve 20 to translate upward, thereby opening the orifice 422 and causing injection of the high pressure fuel into the combustion chamber.

The vent to ambient at the vent 422 plays an important role in the functioning of the present invention. The vent 422 acts to maintain the desired pressure differential, as described above, by venting fuel pressure from a volume, the volume including the underside of the piston 404 and in the needle back chamber 424, to ambient or near ambient (in the area of approximately 50 psi.). Fuel is discharged from the volume in fluid communication with the vent 422 as the needle valve 20 and the actuator piston 404 translate in their respective cylinder bores such that pressure in this volume is at all times negligible.

The end of the injection event is achieved in either of two ways. The first such end involves closing the piezo solenoid 402 first. In such ending, the piezo solenoid 402 is closed before the return of the actuator piston 404 to its retracted disposition. High pressure fuel in passageway 26 is still available and being generated by the intensifier plunger 18. The needle valve 20 closes as a result of the area differential of the head 410 with respect to the front area 30. An advantage of this type of end to the fuel injection is the very sharp (rapid termination) end of fuel injection, since the needle valve 20 closes when the fuel pressure is still very high.

The second way of ending injection is intensifier controlled end of injection. This is similar to the end of injection achieved by the prior art HEUI type injector. In this type of end of injection, the piezo solenoid 402 is open. Return of the intensifier piston 404 to its retracted disposition results in the decay of fuel pressure in the passageway 26. As the fuel pressure in the high pressure fuel passageway 26 drops off, the spring 420 acts on the actuator piston 404 to again close the needle valve 30 as depicted in FIG. 7. It should be noted that in most modes of operation of the present invention, the first method of terminating injection is preferred as the fast end of injection results in HC reduction and reduced smoke generation.

It should be noted that operation of the piezo controlled needle actuation 400 is totally independent of the operation of the intensifier 18. The following are examples of such independent operation.

(1) No Injection.

The piezo controlled direct needle actuation 400 remains closed, as depicted in FIG. 7, all the time resulting in no injection. This is irrespective of operation of the intensifier 18 under control of the pressure control valve 12. Generation of high pressure fuel in the high pressure fuel passageway 26 by the intensifier 18 does not trigger any fuel injection due to the inability of the needle valve 20 to open against the countering force developed by the high pressure fuel in the actuator chamber 408. In this condition, the high pressure fuel generated by the intensifier 18 may be used outside the fuel injector for other engine functions such as, for example, engine valve actuation in a camless engine without interference from fuel injection.

(2) Single Shot Operation.

Single shot operation is essentially a single fuel injection occurrence taking place during an injection event. Prior to initiation of the injection event (t=0), the piezo control direct needle actuation 400 is in the closed position as depicted in FIG. 7. The pressure control valve 12 initiates the injection event by porting actuating fluid to the intensifier 18 at t=0. The intensifier 18 generates the high pressure fuel in the high pressure fuel passageway 26 and in the actuation chamber 408 and at this point the injector is ready for fuel injection. Injection is prevented by the pressure differential caused by the high pressure fuel in the actuation chamber 408, the pressure being substantially equal to that acting on the front area 30,but the force on the piston head 410 being greater due to the greater area of the piston head 410 as compared to the front area 30. The piezo solenoid 402 is then commanded to move to the open position in which fuel pressure is discharged from the actuation chamber 408, shifting the pressure differential in favor of the front area 30. Fuel at high pressure acting on the front area 30 then causes the needle valve 20 to open against the bias force acting on the piston head 410, pressure in the actuation chamber 408 having been bled off. Fuel injection then occurs eruptively, rising almost instantaneously to the maximum rate of injection. It should be noted that a small amount of leakage occurs under this condition through the feed orifice 406. In order to account for this leakage, the intensifier plunger chamber 24 is sized such that there is sufficient high pressure fuel to compensate for the leakage that occurs through the feed orifice 406.

The present invention provides a selection of control strategies. If at t=0, the piezo solenoid 402 is open, the intensifier 18 commences its compressive stroke and generates the high pressure fuel in the high pressure fuel passageway 26 at a relatively slow rate of pressure build up. Fuel pressure acting on the front area 30 then causes the needle valve 20 to open relatively slowly, giving a ramped shape to the rate of injection over time. On the other hand, if at t=0, the piezo solenoid 402 is closed, the intensifier 18 has sufficient time to generate maximum pressure fuel in the high pressure fuel passageway 26. This pressure is also acting on front area 30, but because the piezo solenoid 402 is closed, the needle valve 20 is prevented from opening. When the piezo solenoid 402 is then opened, the needle valve 20 opens virtually instantly and injection occurs eruptively, resulting in a nearly vertical trace of rate of injection over time.

(3) Multiple Injection During a Single Injection Event.

The injection event is initiated and terminated by the pressure control valve 12 acting to port actuation fluid intensifier 18. During the injection event, the pressure control valve 12 need open a single time at the initiation of the injection event and close a single time at the end of the injection event. In this mode of operation, actuating fluid is ported to the intensifier 18 continually during the injection event and the intensifier 18 provides constant high pressure fuel in the high pressure fuel passageway 26 that is available for injection by the needle valve 20. Multiple injection events are controlled directly by the piezo solenoid 402 cycling between the open and closed positioned as desired. Direct actuation of the needle valve 20 under the control of the piezo control direct needle valve actuation 400 is much faster than any other method of actuation, including multiple cycling the relatively large pressure control valve 12, which necessarily involves the relatively inefficient stopping and starting of the intensifier 18. The direct control of the opening of the needle valve 20 as effected by the piezo control direct needle actuation 400 results in a greatly reduced quantity of pilot injection. Further, direct control of the opening of the needle valve 20 as effected by the piezo control direct needle actuation 400 results the in the capability of reducing the dwell time of an injection occurrence for more precise control of the multiple injection occurrences taking place during a single injection event simply by cycling the piezo solenoid 402 independent of the compressive stroke of the intensifier 18.

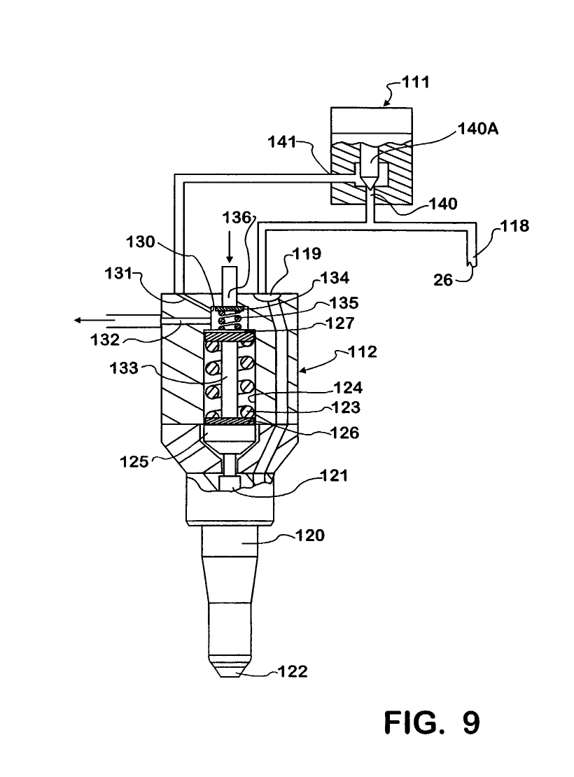

A further embodiment of the present invention is the use of the pressure control valve 12 and intensifier 18 as depicted in FIG. 2 in conjunction with the direct needle control 112 of FIG. 9. FIG. 9 is partially excerpted from U.S. Pat. No. 5,913,300 to Drummond, incorporated herein by reference. In combining the pressure control valve 12 and intensifier 18 of FIG. 2 with the device of FIG. 9, the high pressure fuel passage 26 interfaces with the passageway 118 of FIG. 9, thereby eliminating the pump shown in U.S. Pat. No. 5,913,300. No injection, single shot operation, and multiple injection as described above with reference to the piezo control direct needle actuation 400 is readily achievable by combining the pressure control valve 12 and intensifier 18 with the direct needle actuation device 112 of FIG. 9. Consistent with the description above, pressure control valve 12 is cycled only a single time during an injection event, thereby porting actuation fluid to the intensifier 18 from initiation of the injection event through termination of the injection event as determined by the pressure control valve 12. In this manner, continuous high pressure fuel is available to the passageway 118 of FIG. 9.

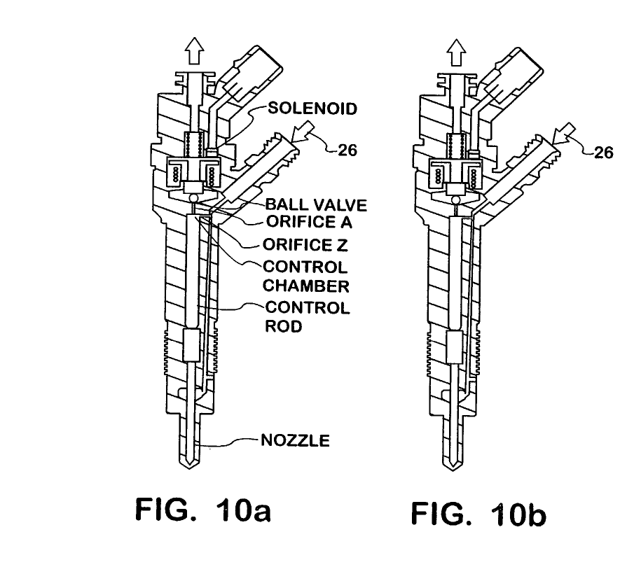

A still further embodiment of the present invention is the combination of the pressure control valve 12 and intensifier 18 of FIG. 2 with the direct needle valve control system depicted in FIGS. 10a and 10b. It should be noted that FIGS. 10a and 10b are excerpted from the previously mentioned SAE paper relating to the common rail fuel system. As with the immediately aforementioned embodiment of the present invention, the pressure control valve 12 need only open to commence the injection event and close to terminate the injection event. During such cycle, actuating fluid is continuously ported to the intensifier 18 such that high pressure fuel is generated continually by the intensifier 18 during the injection event and made available to the high pressure fuel passageway 26 depicted in FIGS. 2 and 10a, 10b. As with previous embodiments of the present invention, the direct needle valve control system depicted in FIGS. 10a and 10b is available to exert its control over the needle valve totally independent of operation of the pressure control valve 12 and intensifier 18. Such independent control permits at least the aforementioned operating conditions of no injection, single shot operation, and multiple injection.

What is claimed is:

1. A fuel injector being fluidly coupled to a source of low pressure fuel and having a fuel pressure intensifier, the fuel intensifier hydraulically amplifying the fuel pressure for injection at a relatively high pressure, comprising:
a fuel injection pressure control valve for preparing fuel pressure; being in flow communication with a source of pressurized actuating fluid and selectively porting such actuating fluid to the fuel intensifier for hydraulic amplification of the fuel pressure; and
a fuel injection timing control valve for controlling the timing of a fuel injection event, the fuel injection pressure control valve and the fuel injection timing control valve being independently controllable.

2. The fuel injector of claim 1 wherein the fuel injection pressure control valve opens a window of injection opportunity and the fuel injection timing control valve controls the timing and duration of an injection event that occurs within the window of injection opportunity.

3. The fuel injector of claim 2 wherein the fuel injection pressure control valve opens a window of injection opportunity during which an actuation pressure is made available for use to intensify a fuel pressure.

4. The fuel injector of claim 2 wherein the fuel injection timing control valve controls the timing and duration of an injection event that occurs within the window of injection opportunity to define fuel injection parameters.

5. The fuel injector of claim 4 wherein the fuel injection parameters occurring within an injection event include at least one of the parameters being start of injection, end of injection, interruption of injection, timing of interruption of injection, and duration of interruption of injection.

6. The fuel injector of claim 1 wherein the fuel injection timing control valve provides for selective independent control of pilot injection, main injection and rate shaping within a single shot injection event.

7. The fuel injector of claim 1 wherein fuel injection pressure preparation and fuel injection timing control are internally determined and are decoupled.

8. The fuel injector of claim 1 wherein the fuel injection timing control valve has relatively less flow area in relation to the fuel injection pressure control valve, the lesser flow area enhancing the response time of the fuel injection timing control valve for improving the shaping of the injection event as desired.

9. The fuel injector of claim 1 wherein a full actuation pressure is available from the fuel injection pressure control valve for the duration of an injection event, thereby providing maximum injection pressure throughout the injection event without regard to shaping of the injection event as desired.

10. The fuel injector of claim 1 wherein the fuel injection pressure control valve for preparing fuel pressure is cycled opened and closed a single time during each injection event and the fuel injection timing control valve may be independently cycled opened and closed a plurality of cycles during single time during each injection event for effecting shaping of the injection event as desired.

11. A hydraulically actuated, electronically controlled unit injector having an inlet for admitting non-fuel actuating fluid to the injector and a fuel inlet for admitting a quantity of fuel at a pressure that is less than a pressure necessary to open a needle valve to cause fuel injection, an intensifier for selectively pressurizing the quantity of fuel to a pressure sufficient to open the needle valve when the intensifier is acted upon the actuating fluid, the pressurized fuel being available for control of the needle valve continuously during an injection event, the unit injector comprising:
a timing controller in fluid communication with the needle valve and with the intensifier being decoupled from actuation of the intensifier and controlling the shifting of the valve between an open and a closed disposition during an injection event by controlling a flow of pressurized fuel from the intensifier to the needle valve.

12. The hydraulically actuated, electronically controlled unit injector of claim 11 wherein the timing controller directly controls the shifting of the needle valve.

13. The hydraulically actuated, electronically controlled unit injector of claim 12 wherein the timing controller directly controls the shifting of the needle valve by selectively porting a flow of pressurized fuel to exert a force on a needle valve surface, the force acting bias the needle valve in a closed disposition.

14. The hydraulically actuated, electronically controlled unit injector of claim 11 wherein the timing controller includes an electronically actuated controller valve, the controller valve being in fluid communication with a fuel passage extending between the intensifier and the needle valve, the fuel passage conveying high pressure fuel.

15. The hydraulically actuated, electronically controlled unit injector of claim 14 wherein the controller valve is in fluid communication with a controller chamber, the controller chamber being defined in part by a needle valve surface, the timing controller porting high pressure fuel to the needle valve surface when the controller valve is in an open disposition.

16. The hydraulically actuated, electronically controlled unit injector of claim 15 wherein the controller chamber is in fluid communication with a fuel reservoir via a fuel refill passage, the controller chamber being refilled with fuel when the controller valve is in a closed disposition.

17. A hydraulically actuated, electronically controlled unit injector having an inlet for admitting non-fuel actuating fluid to the injector and a fuel inlet for admitting a quantity of fuel at a pressure that is less than a pressure necessary to open a needle valve to cause fuel injection, an intensifier for selectively pressurizing the quantity of fuel to a pressure sufficient to open the needle valve when the intensifier is acted upon the actuating fluid, the pressurized fuel being available for control of the needle valve continuously during an injection event, the unit injector comprising:
a timing controller in fluid communication with the needle valve and with the intensifier being decoupled from actuation of the intensifier and controlling the shifting of the valve between an open and a closed disposition during an injection event by controlling a flow of pressurized fuel from the intensifier to the needle valve, the timing controller including an electronically actuated controller valve, the controller valve being in fluid communication with a fuel passage extending between the intensifier and the needle valve, the fuel passage conveying high pressure fuel, the controller chamber is in fluid communication with a fuel reservoir via a fuel refill passage, the controller chamber being refilled with fuel when the controller valve is in a closed disposition, the controller chamber being further in fluid communication with the fuel reservoir via a drain orifice, the drain orifice being open at all times.
